(19) United States
(12) Patent Application Publication
(10) Pub. No.: US 2025/0183338 A1
(43) Pub. Date: Jun. 5, 2025

(54) IN SITU MONITORING SYSTEM OF STACK COMPRESSION AND METHOD OF USING THE SAME

(71) Applicant: CUMMINS INC., Columbus, IN (US)

(72) Inventors: Adam C. CECIL, Columbus, IN (US); David P. GENTER, Columbus, IN (US); Robert Earl HOYE, Bloomington, IN (US); Dustin VICKRESS, Mississauga (CA)

(21) Appl. No.: 18/934,663

(22) Filed: Nov. 1, 2024

Related U.S. Application Data
(60) Provisional application No. 63/604,702, filed on Nov. 30, 2023.

(51) Int. Cl. H01M 8/04664; H01M 8/2475; H01M 8/248

(52) U.S. Cl. CPC H01M 8/04679; H01M 8/2475; H01M 8/248; H01M 2250/20

(57) ABSTRACT

An in situ monitoring system of compression load on a stack includes a stack assembly, a tie rod assembly, and a compression load measurement device. The stack assembly includes the stack, a first endplate, and a second endplate that cooperate to apply a compression load to the stack. The tie rod assembly includes a tie rod that extends between the first endplate and the second endplate. The compression load measurement device is coupled to the tie rod or the first and second endplates and configured to determine the compression load applied to the stack during operation of the stack.

### CROSS-REFERENCE TO RELATED APPLICATIONS

This nonprovisional application claims the benefit and priority, under 35 U.S.C. § 119(e) and any other applicable laws or statues, to U.S. Provisional Patent Application Ser. No. 63/604,702 filed on Nov. 30, 2023, the entire disclosure of which is hereby expressly incorporated herein by reference.

### TECHNICAL FIELD

The present disclosure relates to in situ monitoring systems and methods of using in situ monitoring systems to determine a compression load applied to a stack.

### SUMMARY

Embodiments of the present disclosure are included to meet these and other needs.

In one aspect described herein, an in situ monitoring system of compression load on a stack comprises a stack assembly, a tie rod assembly, and a compression load measurement device. The stack assembly includes the stack, a first endplate arranged on a first side of the stack, and a second endplate arranged on a second side of the stack opposite the first side. The first endplate and the second endplate cooperate to apply a compression load to the stack. The tie rod assembly includes a tie rod extending between the first endplate and the second endplate. The tie rod is configured to adjust the compression load applied to the stack through the first endplate and the second endplate. The compression load measurement device is coupled to the tie rod or the stack assembly and configured to measure in real time the compression load applied to the stack during operation of the stack.

In some embodiments, the stack may be a fuel cell stack. In some embodiments, the stack may be an electrolyzer stack. In some embodiments, the tie rod may be formed to include a non-threaded portion and a threaded portion on either side of the non-threaded portion. In some embodiments, the compression load measurement device may comprise a strain gauge coupled to the non-threaded portion of the tie rod. In some embodiments, the tie rod assembly may include a first sleeve and a second sleeve that each slide onto the tie rod and cooperate to form a hole. The strain gauge may extend from the non-threaded portion of the tie rod and through the hole.

In some embodiments, the tie rod assembly may include a second tie rod extending between the first endplate and the second endplate. In some embodiments, an entirety of the second tie rod may be threaded. In some embodiments, the in situ monitoring system may further comprise a controller operably connected to the compression load measurement device. In some embodiments, the controller may be configured to compare the compression load as determined by the compression load measurement device to a desired compression load range. In some embodiments, the in situ monitoring system is stationary.

According to a second aspect, described herein, a method of in situ monitoring of a compression load on a stack includes arranging the stack between a first endplate and a second endplate. The method includes extending a tie rod between the first endplate and the second endplate. The method includes applying the compression load to the stack through the first endplate and the second endplate. The method includes coupling a compression load measurement device to the tie rod or at least one of the first endplate and the second endplate. The method includes measuring the compression load being applied to the stack during operation of the stack using the compression load measurement device to determine a determined compression load. The method includes comparing the determined compression load with a desired compression load range.

In some embodiments, the method may include issuing an alert in response to the determined compression load being outside of the desired compression load range. In some embodiments, the method may include adjusting the compression load being applied to the stack in response to the determined compression load being outside of the desired compression load range. In some embodiments, the step of coupling a compression load measurement device may include coupling a strain gauge to a non-threaded portion of the tie rod and measuring a strain of the tie rod to obtain a measured strain of the tie rod.

In some embodiments, the method may include, determining the compression load being applied to the stack based on the measured strain of the tie rod. In some embodiments, the stack may be a fuel cell stack. In some embodiments, the stack may be an electrolyzer stack. In some embodiments, the method may include, predicting an end of life of the stack based on the determined compression load. In some embodiments, the method may include, maintaining a stationary position of the compression load measurement device and the stack.

In some embodiments, the method may include sliding a first sleeve and a second sleeve onto the tie rod, the first sleeve and the second sleeve cooperating to form a hole that a portion of the compression load measurement device extends through. In some embodiments, the method may include repeating the steps of determining the compression load being applied to the stack during operation of the stack using the compression load measurement device and comparing the determined compression load with the desired compression load range throughout a life cycle of the stack.

### BRIEF DESCRIPTION OF THE DRAWINGS

FIG. 1A is a schematic view of an exemplary fuel cell system including an air delivery system, a hydrogen delivery system, and a fuel cell module including a stack of multiple fuel cells;

FIG. 1B is a cutaway view of an exemplary fuel cell system including an air delivery system, hydrogen delivery systems, and a plurality of fuel cell modules each including multiple fuel cell stacks;

FIG. 1C is a perspective view of an exemplary repeating unit of a fuel cell stack of the fuel cell system of FIG. 1A;

FIG. 1D is a cross-sectional view of an exemplary repeating unit of the fuel cell stack of FIG. 1C;

FIG. 2A is perspective view of an electrolyzer cell stack according to the present disclosure;

FIG. 2B is a schematic view of an electrolysis system configured to utilize the electrolyzer cell stack of FIG. 2A;

FIG. 2C is a schematic view of an additional portion of the electrolysis system of FIG. 2B;

FIG. 3 is a front view of an in situ monitoring system including a stack assembly, a tie rod assembly, and a compression load measurement device that determines a compression load applied to a stack of the stack assembly during operation of the stack;

FIG. 4 is a cross sectional view of the in situ monitoring system of FIG. 3 showing that the compression load measurement device is coupled to at least one tie rod included in the tie rod assembly;

FIG. 5 is an enlarged view of the at least one tie rod of FIG. 4, the at least one tie rod having a threaded portion and a non-threaded portion that the compression load measurement device is coupled thereto;

FIG. 6 is a perspective view of the in situ monitoring system of FIG. 3 showing that the at least one tie rod extends through a second endplate of the stack assembly so that the non-threaded portion of the at least one tie rod is located above the second endplate;

FIG. 7 is a perspective view of the at least one tie rod with a first sleeve and a second sleeve inserted onto the at least one tie rod, the first sleeve and the second sleeve cooperating to form a hole for a portion of the compression load measurement device to extend through;

FIG. 8 is an enlarged view of the hole of FIG. 7;

FIG. 9 is a perspective view of the in situ monitoring system of FIG. 3 showing that a housing extends around an exterior of the stack and the tie rod assembly;

FIG. 10 is a perspective view of the in situ monitoring system of FIG. 3 showing that a set of wires of the compression load measurement device extends through a channel formed in the housing and exits the housing through an outlet port;

FIG. 11 is an enlarged view of a portion of the housing of FIG. 9 showing that the housing includes clips that engage the tie rods to couple the housing to the stack assembly;

FIG. 12 is an enlarged view of a portion of the housing of FIG. 9 showing that the channel of the housing is formed between an outer wall and an inner wall of the housing;

FIG. 13 is an enlarged view of the in situ monitoring system of FIG. 3 showing that the set of wires of the compression load measurement device extend through the hole formed between the first and second sleeves of the tie rod assembly and into the channel formed in the housing;

FIG. 14 is a perspective view of the housing before it is coupled with the tie rods;

FIG. 15 is a perspective view of the housing coupled with the tie rods;

FIG. 16 is a perspective view of the set of wires exiting the outlet port of the housing;

FIG. 17 is an exploded view of a portion of the tie rod assembly; and

FIG. 18 is a perspective view of an alternative embodiment of an in situ monitoring system.

### DETAILED DESCRIPTION

Fuel cell systems are known for their efficient use of fuel to produce direct current electric energy to power mobile applications, such as, for example, vehicles, trains, buses, and trucks. Electrolyzer systems are known for their efficient use of water and electricity to produce hydrogen and oxygen. Typical fuel cell systems and electrolyzer systems include endplates on either end of a fuel cell stack or an electrolyzer stack to compress cells within each stack.

The endplates maintain the structure of the stacks as well as prevent fluids from escaping the stacks. A compression load applied by the endplates to the stacks may change over time as the compression load is dependent on the duty cycle of the stack. Because the compression load may change over time, it may be advantageous to monitor the compression load in real time.

The present disclosure is directed to an in situ monitoring system of stack compression and methods of using the in situ monitoring system to monitor the compression load applied to the stack in real time. For example, in situ monitoring of the stack compression may be useful so that the stack compression may be adjusted if needed.

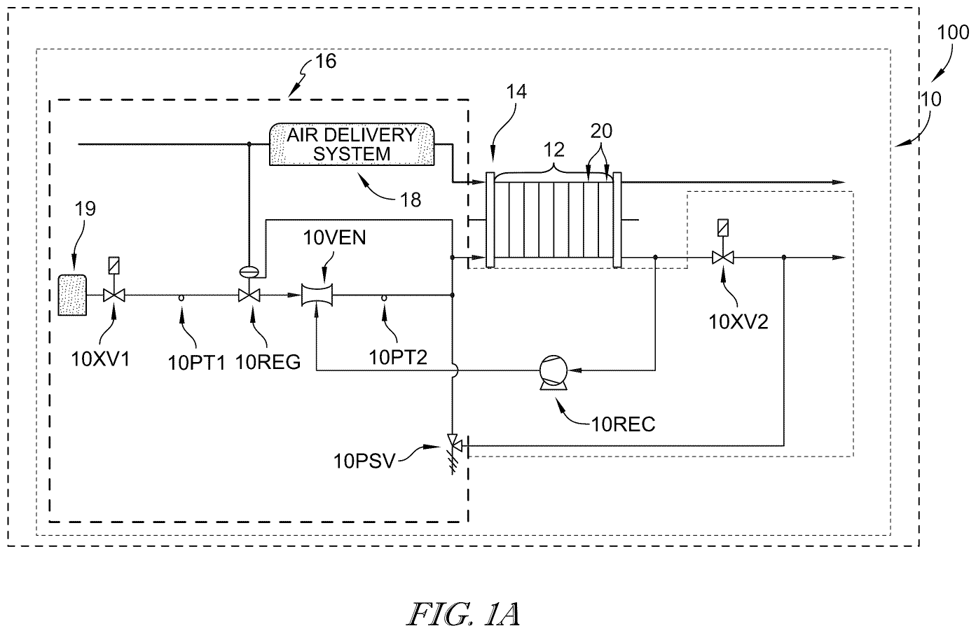

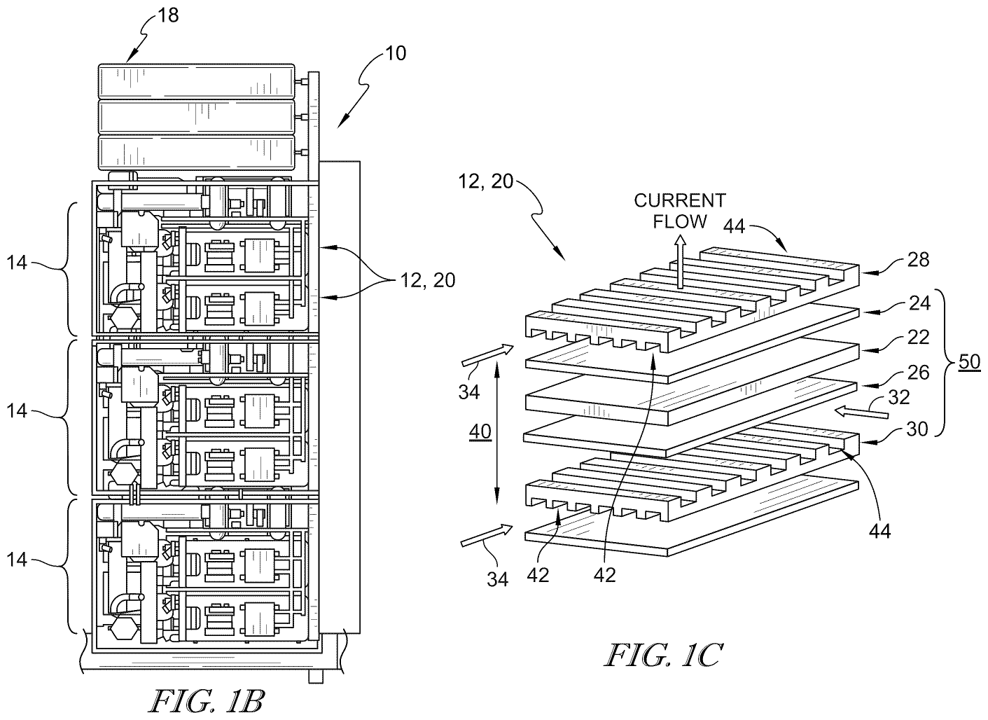

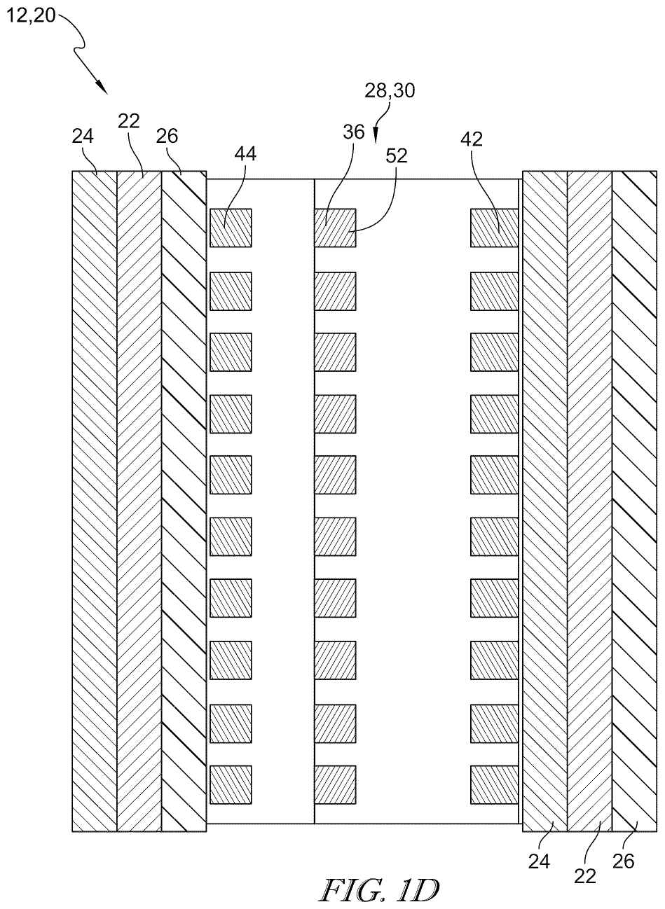

As shown in FIG. 1A, fuel cell systems 10 often include one or more fuel cell stacks 12 or fuel cell modules 14 connected to a balance of plant (BOP) 16, including various components, to support the electrochemical conversion, generation, and/or distribution of electrical power to help meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 assembled together in series and/or in parallel. The fuel cell system 10 may include one or more fuel cell modules 14, as shown in FIGS. 1A and 1B. In some embodiments, the fuel cell system 10 may comprise one or more fuel cell stacks 12.

Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals, and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layers (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26, as shown in FIG. 1C. The above-mentioned components, in particular the bipolar plate 30, the gas diffusion layer (GDL) 26, the membrane electrode assembly (MEA) 22, and the gas diffusion layer (GDL) 24 comprise a single repeating unit 50.

The bipolar plates (BPP) 28, 30 are responsible for the transport of reactants, such as fuel 32 (e.g., hydrogen) or oxidant 34 (e.g., oxygen, air), and cooling liquid 36 (e.g., coolant and/or water) in a fuel cell 20. The bipolar plates (BPP) 28, 30 can uniformly distribute reactants 32, 34 to an active area 40 of each fuel cell 20 through oxidant flow fields 42 and/or fuel flow fields 44 formed on outer surfaces of the bipolar plates (BPP) 28, 30. The active area 40, where the electrochemical reactions occur to generate electrical power produced by the fuel cell 20, is centered, when viewing the stack 12 from a top-down perspective, within the membrane electrode assembly (MEA) 22, the gas diffusion layers (GDL) 24, 26, and the bipolar plate (BPP) 28, 30.

The bipolar plates (BPP) 28, 30 may each be formed to have reactant flow fields 42, 44 formed on opposing outer surfaces of the bipolar plate (BPP) 28, 30, and formed to have coolant flow fields 52 located within the bipolar plate (BPP) 28, 30, as shown in FIG. 1D. For example, the bipolar plate (BPP) 28, 30 can include fuel flow fields 44 for transfer of fuel 32 on one side of the plate 28, 30 for interaction with the gas diffusion layer (GDL) 26. The bipolar plate (BPP) 28, 30 also includes oxidant flow fields 42 for transfer of oxidant 34 on the second, opposite side of the plate 28, 30 for interaction with the gas diffusion layer (GDL) 24.

As shown in FIG. 1D, the bipolar plates (BPP) 28, 30 can further include coolant flow fields 52 formed within the plate (BPP) 28, 30, generally centrally between the opposing outer surfaces of the plate (BPP) 28, 30. The coolant flow fields 52 facilitate the flow of cooling liquid 36 through the bipolar plate (BPP) 28, 30 in order to regulate the temperature of the plate (BPP) 28, 30 materials and the reactants. The bipolar plates (BPP) 28, 30 are compressed against adjacent gas diffusion layers (GDL) 24, 26 to isolate and/or seal one or more reactants 32, 34 within their respective pathways 44, 42 to maintain electrical conductivity, which is required for robust operation of the fuel cell 20 (see FIGS. 1C and 1D).

The fuel cell system 10 described herein may be used in stationary and/or immovable power system, such as industrial applications and power generation plants. The fuel cell system 10 may also be implemented in conjunction with an air delivery system 18. Additionally, the fuel cell system 10 may also be implemented in conjunction with a hydrogen delivery system and/or a source of hydrogen 19 such as a pressurized tank, including a gaseous pressurized tank, cryogenic liquid storage tank, chemical storage, physical storage, stationary storage, an electrolysis system or an electrolyzer. In one embodiment, the fuel cell system 10 is connected and/or attached in series or parallel to a hydrogen delivery system and/or a source of hydrogen 19, such as one or more hydrogen delivery systems and/or sources of hydrogen 19 in the BOP 16 (see FIG. 1A). In another embodiment, the fuel cell system 10 is not connected and/or attached in series or parallel to a hydrogen delivery system and/or a source of hydrogen 19.

In some embodiments, the fuel cell system 10 may include an on/off valve 10XV1, a pressure transducer 10PT1, a mechanical regulator 10REG, and a venturi 10VEN arranged in operable communication with each other and downstream of the hydrogen delivery system and/or source of hydrogen 19, as shown in FIG. 1A. The pressure transducer 10PT1 may be arranged between the on/off valve 10XV1 and the mechanical regulator 10REG. In some embodiments, a proportional control valve may be utilized instead of a mechanical regulator 10REG. In some embodiments, a second pressure transducer 10PT2 is arranged downstream of the venturi 10VEN, which is downstream of the mechanical regulator 10REG.

In some embodiments, the fuel cell system 10 may further include a recirculation pump 10REC downstream of the stack 12 and operably connected to the venturi 10VEN, as shown in FIG. 1A. The fuel cell system 10 may also include a further on/off valve 10XV2 downstream of the stack 12, and a pressure transfer valve 10PSV, as shown in FIG. 1A.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy-duty vehicle. Types of vehicles 100 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

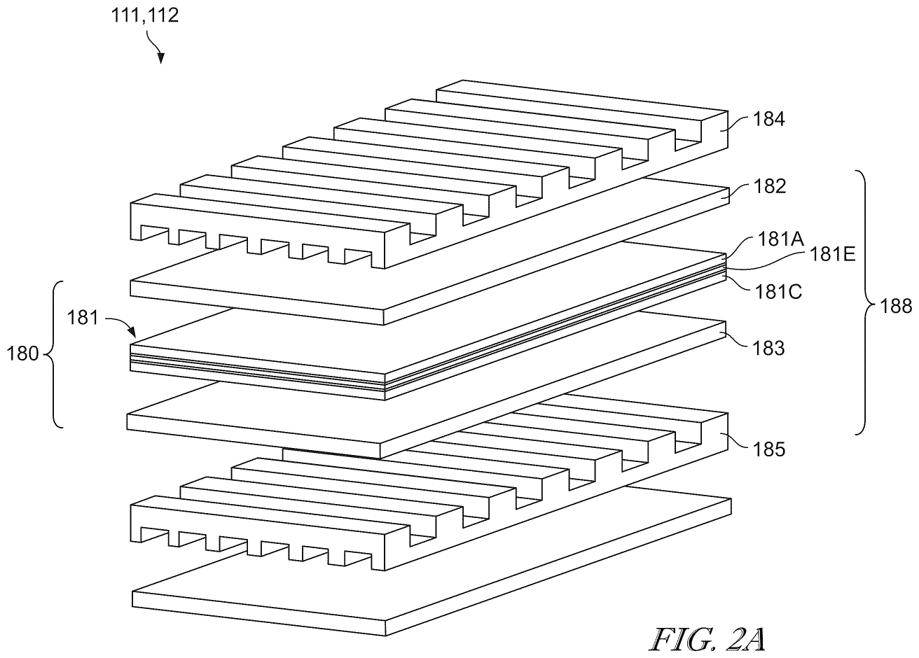

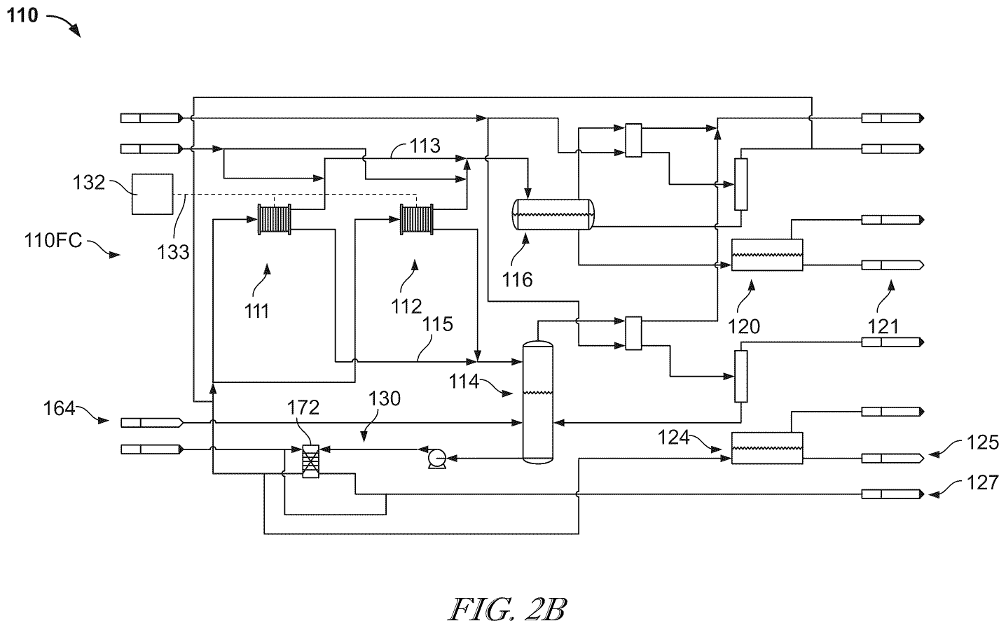

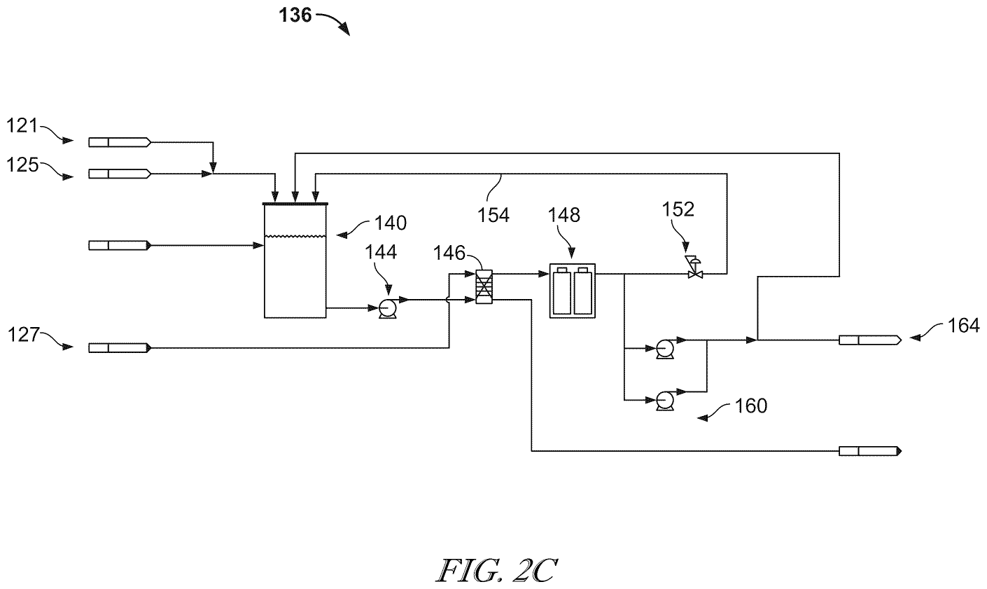

As shown in FIGS. 2A and 2B, electrolysis systems 110 are typically configured to utilize water and electricity to produce hydrogen and oxygen. An electrolysis system 110 typically includes one or more electrolyzer cells 180 that utilize electricity to chemically produce substantially pure hydrogen 113 and oxygen 115 from deionized water 130. Often the electrical source for the electrolysis systems 110 is produced from power or energy generation systems, including renewable energy systems such as wind, solar, hydroelectric, and geothermal sources for the production of green hydrogen. In turn, the pure hydrogen produced by the electrolysis systems 110 is often utilized as a fuel or energy source for those same power generation systems, such as fuel cell systems. Alternatively, the pure hydrogen produced by the electrolysis systems 110 may be stored for later use.

The typical electrolyzer cell 180, or electrolytic cell, is comprised of multiple assemblies compressed and bound into a single assembly, and multiple electrolyzer cells 180 may be stacked relative to each other, along with bipolar plates (BPP) 184, 185 therebetween, to form an electrolyzer cell stack (for example, electrolyzer cell stacks 111, 112 in FIG. 2B). Each electrolyzer cell stack 111, 112 may house a plurality of electrolyzer cells 180 connected together in series and/or in parallel. The number of electrolyzer cell stacks 111, 112 in the electrolysis systems 110 can vary depending on the amount of power required to meet the power need of any load (e.g., fuel cell stack). The number of electrolyzer cells 180 in an electrolyzer cell stack 111, 112 can vary depending on the amount of power required to operate the electrolysis systems 110 including the electrolyzer cell stack 111, 112.

An electrolyzer cell 180 includes a multi-component membrane electrode assembly (MEA) 181 that has an electrolyte 181E, an anode 181A, and a cathode 181C. Typically, the anode 181A, cathode 181C, and electrolyte 181E of the membrane electrode assembly (MEA) 181 are configured in a multi-layer arrangement that enables the electrochemical reaction to produce hydrogen and/or oxygen via contact of the water with one or more gas diffusion layers 182, 183. The gas diffusion layers (GDL) 182, 183, which may also be referred to as porous transport layers (PTL), are typically located on one or both sides of the MEA 181. Bipolar plates (BPP) 184, 185 often reside on either side of the GDLs and separate the individual electrolyzer cells 180 of the electrolyzer cell stack 111, 112 from one another. One bipolar plate 185 and the adjacent gas diffusion layers 182, 183 and MEA 181 can form a repeating unit 188.

As shown in FIGS. 2B and 2C, an exemplary electrolysis system 110 can include two electrolyzer cell stacks 111, 112 and a fluidic circuit 110FC including the various fluidic pathways shown in FIGS. 2B and 2C that is configured to circulate, inject, and purge fluid and other components to and from the electrolysis systems 110. A person skilled in the art would understand that one or a variety of a number of components within the fluidic circuit 110FC, as well as more or less than two electrolyzer cell stacks 111, 112, may be utilized in the electrolysis systems 110. For example, the electrolysis systems 110 may include one electrolyzer cell stack 111, and in other examples, the electrolysis systems 110 may include three or more electrolyzer cell stacks.

The electrolysis systems 110 may include one or more types of electrolyzer cell stacks 111, 112 therein. In the illustrated embodiment, a polymer electrolyte membrane (PEM) electrolyzer cell 180 may be utilized in the stacks 111, 112. A PEM electrolyzer cell 180 typically operates at about 4° C. to about 150° C., including any specific or range of temperatures comprised therein. A PEM electrolyzer cell 180 also typically functions at about 100 bar or less, but can go up to about 1000 bar (including any specific or range of pressures comprised therein), which reduces the total energy demand of the system. A standard electrochemical reaction that occurs in a PEM electrolyzer cell 180 to produce hydrogen is as follows.

Anode: 2H₂O→O₂+4H⁺+4ₑ⁻

Cathode: 4H⁺+4e⁻→2H₂

Overall: 2H₂O (liquid)→2H₂+O₂

Additionally, a solid oxide electrolyzer cell 180 may be utilized in the electrolysis systems 110. A solid oxide electrolyzer cell 180 will function at about 500° C. to about 1000° C., including any specific or range of temperatures comprised therein. A standard electrochemical reaction that occurs in a solid oxide electrolyzer cell 180 to produce hydrogen is as follows.

Anode: 2O²⁻→O₂+4e⁻

Cathode: 2H₂O→4e⁻+2H₂+2O²⁻

Overall: 2H₂O (liquid)→2H₂+O₂

Moreover, an AEM electrolyzer cell 180 may utilized, which uses an alkaline media. An exemplary AEM electrolyzer cell 180 is an alkaline electrolyzer cell 180. Alkaline electrolyzer cells 180 comprise aqueous solutions, such as potassium hydroxide (KOH) and/or sodium hydroxide (NaOH), as the electrolyte. Alkaline electrolyzer cells 180 typically perform at operating temperatures ranging from about 0° C. to about 150° C., including any specific or range of temperatures comprised therein. Alkaline electrolyzer cell 180 generally operate at pressures ranging from about 1 bar to about 100 bar, including any specific or range of pressures comprised therein. A typical hydrogen-generating electrochemical reaction that occurs in an alkaline electrolyzer cell 180 is as follows.

Anode: 4OH⁻→O₂+2H₂O+4e⁻

Cathode: 4H₂O+4e⁻→2H₂+4OH⁻

Overall: 2H₂O 2H₂+O₂

As shown in FIG. 2B, the electrolyzer cell stacks 111, 112 include one or more electrolyzer cells 180 that utilize electricity to chemically produce substantially pure hydrogen and oxygen from water. In turn, the pure hydrogen produced by the electrolyzer may be utilized as a fuel or energy source. As shown in FIG. 2B, the electrolyzer cell stack 111, 112 outputs the produced hydrogen along a fluidic connecting line 113 to a hydrogen separator 116, and also outputs the produced oxygen along a fluidic connecting line 115 to an oxygen separator 114.

The hydrogen separator 116 may be configured to output pure hydrogen gas and also send additional output fluid to a hydrogen drain tank 120, which then outputs fluid to a deionized water drain 121. The oxygen separator 114 may output fluid to an oxygen drain tank 124, which in turn outputs fluid to a deionized water drain 125. A person skilled in the art would understand that certain inputs and outputs of fluid may be pure water or other fluids such as coolant or byproducts of the chemical reactions of the electrolyzer cell stacks 111, 112. For example, oxygen and hydrogen may flow away from the cell stacks 111, 112 to the respective separators 114, 116. The system 110 may further include a rectifier 132 configured to convert electricity 133 flowing to the cell stacks 111, 112 from alternating current (AC) to direct current (DC).

The deionized water drains 121, 125 each output to a deionized water tank 140, which is part of a polishing loop 136 of the fluidic circuit 110FC, as shown in FIG. 2C. Water with ion content can damage electrolyzer cell stacks 111, 112 when the ionized water interacts with internal components of the electrolyzer cell stacks 111, 112. The polishing loop 136, shown in greater detail in FIG. 2C, is configured to deionize the water such that it may be utilized in the cell stacks 111, 112 and not damage the cell stacks 111, 112.

In the illustrated embodiment, the deionized water tank 140 outputs fluid, in particular water, to a deionized water polishing pump 144. The deionized water polishing pump 144 in turn outputs the water to a water polishing heat exchanger 146 for polishing and treatment. The water then flows to a deionized water resin tank 148.

Coolant is directed through the electrolysis systems 110, in particular through a deionized water heat exchanger 172 that is fluidically connected to the oxygen separator 114. The coolant used to cool said water may also be subsequently fed to the water polishing heat exchanger 146 via a coolant input 127 for polishing. The coolant is then output back to the deionized water heat exchanger 172 for cooling the water therein.

After the water is output from the deionized water polishing heat exchanger 146 and subsequently to the deionized water resin tank 148, a portion of the water may be fed to deionized water high pressure feed pumps 160. Another portion of the water may be fed to a deionized water pressure control valve 152, as shown in FIG. 2C. The portion of the water that is fed to the deionized water pressure control valve 152 flows through a recirculation fluidic connection 154 that allows the water to flow back to the deionized water tank 140 for continued polishing.

In some embodiments, the electrolysis systems 110 may increase deionized water skid for polishing water flow to flush out ions within the water at a faster rate. The portion of the water that is fed to the deionized water high pressure feed pumps 160 is then output to a deionized water feed 164, which then flows into the oxygen separator 114 for recirculation and eventual reusage in the electrolyzer cell stacks 111, 112. This process may then continuously repeat.

The electrolysis systems 110 described herein, may be used in stationary and/or immovable power system, such as industrial applications and power generation plants. The electrolysis systems 110 may also be implemented in conjunction with other electrolysis systems 110.

The present electrolysis systems 110 may be comprised in mobile applications. The electrolysis systems 110 may be in the vehicle or the powertrain 100. The vehicle or powertrain 100 comprising the electrolysis systems 110 may be an automobile, a pass car, a bus, a truck, a train, a locomotive, an aircraft, a light duty vehicle, a medium duty vehicle, or a heavy duty vehicle.

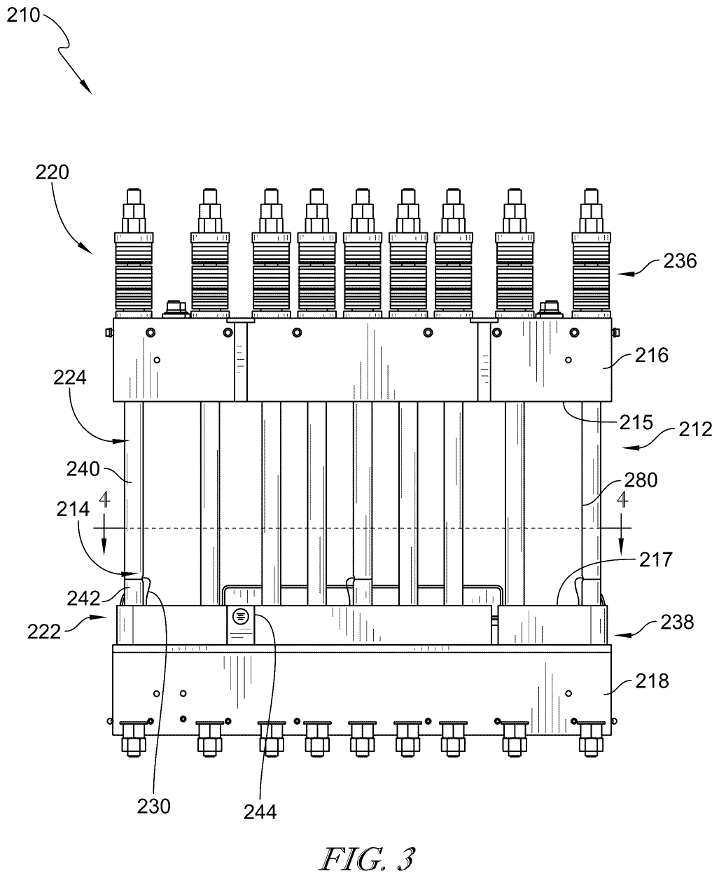

The present disclosure provides an in situ monitoring system 210 including a stack assembly 212, as shown in FIG. 3. The stack assembly 212 includes a stack 214, a first endplate 216, and/or a second endplate 218. The stack 214 may be the fuel cell stack 12 or the electrolyzer cell stack 111, 112 as described above. The first endplate 216 is located on a first side 215 of the stack 214. The second endplate 218 is located on a second side 217 of the stack 214 opposite the first side 215. In some embodiments, the in situ monitoring system 210 and the stack assembly 212 are stationary. In other embodiments, the in situ monitoring system 210 and the stack assembly 212 may be configured to be mobile and/or portable.

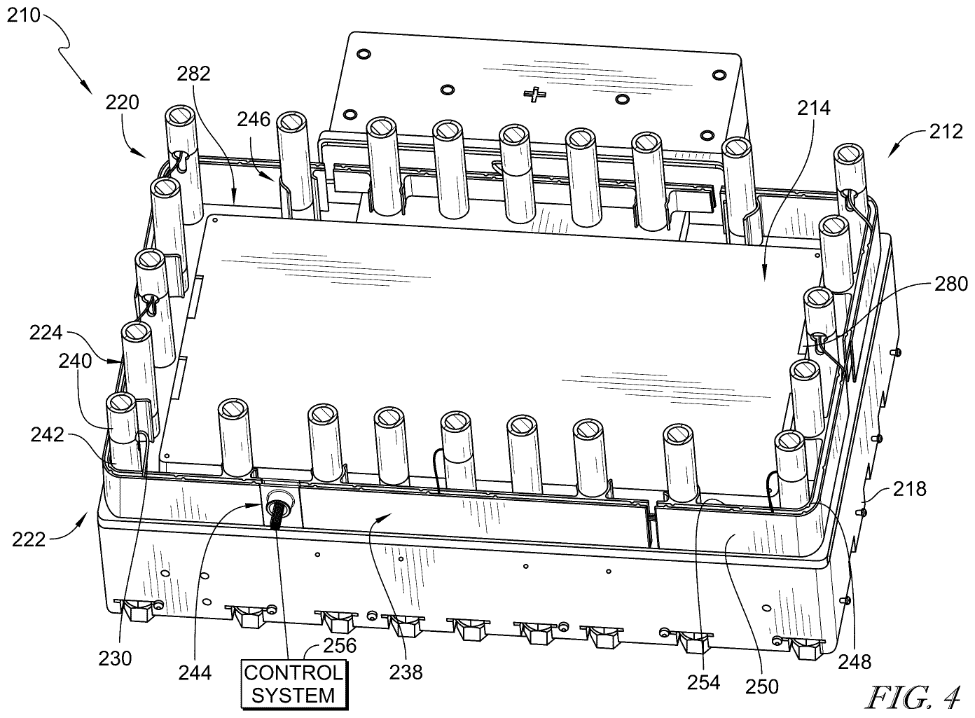

The number of cells, such as the fuel cells 20 and/or the electrolyzer cells 180, in the stack 214 may be any number. For example, the number of cells 20, 180 in the stack 214 may range from about 100 cells to about 1000 cells, including any specific number or range of number of cells 20 comprised therein. The cells 20, 180 may require sealing between each cell 20, 180 and between each layer within the individual cells 20, 180. The sealing between each cell 20, 180 and/or cell layer may be configured using a seal 280, as shown in FIGS. 3 and 4.

The seal 280 between cells 20, 180 of the stack 214, the first endplate 216, and the second endplate 218 occurs by applying a pressure and/or a compression load to the stack 214. Maintaining an adequate pressure and/or compression load over a lifecycle of the stack 214 helps to increase the reliability and durability of the stack 214. Illustratively, a desired compression load range for the pressure and/or compression load applied to the stack 214 to have optimal performance ranges from about 2 MPa to about 20 MPa, including any specific range or number comprised therein. It will be understood that the desired compression load range varies based on the type of stack 214, the type of endplates 216, 218, the number of cells 20, 180, the types of fasteners used within the stack assembly 212, and/or other variables. In other words, illustratively, the minimum compression load that should be applied to the stack 214 is the lower number of the desired compression load range, and the maximum compression load that should be applied to the stack 214 is the upper number of the desired compression load range in order to maximize functional and/or operational performance and/or the life of the stack 214.

If the compression load applied to the stack 214 is less than the minimum compression load of the desired compression load range described herein, the stack 214 may not be sealed properly and/or the stack 214 may not operationally perform as efficiently. If the compression load applied to the stack 214 is higher than the maximum compression load of the desired compression load range described herein, the stack 214 may be damaged. Damage to the stack 214 may adversely impact the reliability, durability, life, and/or performance of the stack 214. For example, the operational efficiency of the stack 214 may decrease if the compression load is too high. Additionally, the rate at which the stack 214 degrades may increase if the compression load is too high.

During manufacturing of the stack assembly 212, the range of desired compression load on the stack 214 is set while the stack 214 is not yet pressurized or subject to varying temperatures. However, during operation, the stack 214 is pressurized and exposed to an elevated operating temperature that may range from about 60° C. to about 1000° C. (depending on the type of fuel cell 20 or electrolyzer cell 180). The compression load applied to the stack 214 changes over time as the compression load is dependent on the duty cycle of the stack assembly 212. Therefore, it may be important or advantageous to monitor the compression load applied to the stack 214 in real time during operation of the stack 214 to maintain the compression load within the desired compression load range. In real time refers to monitoring of the compression load as the compression load is being applied to the stack 214 or at the time that the compression load is being applied to the stack 214. There is minimal, if any, lag, pause, delay, or interruption in monitoring. At a specific time, the compression load may be monitored to determine what the compression load is at the specific time.

The in situ monitoring system 210 further includes a control system 256 (e.g., a controller 256), as shown in FIG. 4. The control system 256 may monitor, regulate, and/or measure stack assembly 212 or stack 214 parameters, including, but not limited to, compression loads, strains, pressures, temperatures, flow rates, voltages, currents, etc., among other parameters. In some embodiments, the control system 256 may monitor, regulate, and/or measure stack assembly 212 or stack 214 parameters in due course (e.g., when it makes logistical, systemic, and/or economic sense to do so). In some embodiments, the control system 256 may monitor, regulate, and/or measure stack assembly 212 or stack 214 parameters in real time.

The phrase in real time refers to at least one of the times of occurrence of the associated events, e.g., the time of measurement and collection of parameters, the time to process the parameters, and/or the time of a system response to the parameters occur instantaneously or substantially instantaneously. Systems, components, and/or methods operating or functioning in real time are doing so instantaneously or substantially instantaneously (e.g., in the present or current time). For example, stack assembly 212 or stack 214 parameters can be accessed and/or assessed in real time (e.g., instantaneously or substantially instantaneously) by the control system 256. Additionally, the control system 256 may then control, monitor, and/or regulate the operation of the different components of the stack assembly 212 in real time and/or in due course.

Beyond the stack assembly 212 and the control system 256, the in situ monitoring system 210 includes a tie rod assembly 220 and/or a measurement device 222, as shown in FIGS. 3 and 4. The tie rod assembly 220 includes a plurality of tie rods 224 that extend vertically between the first endplate 216 and the second endplate 218. A height or a length of the plurality of tie rods 224 between the first and second endplates 216, 218 may extend from about 500 mm to about 2,000 mm, including any specific or range of lengths comprised therein.

The plurality of tie rods 224 are spaced apart from one another around a perimeter 282 of the stack 214, as shown in FIG. 4. The spacing and/or location between each of the plurality of tie rods 224 around the perimeter 282 may be the same and/or different. The plurality of tie rods 224 may be in any position that allows the best assessment of the compression load, pressure, and/or other variables measured to assess or calculate the compression load.

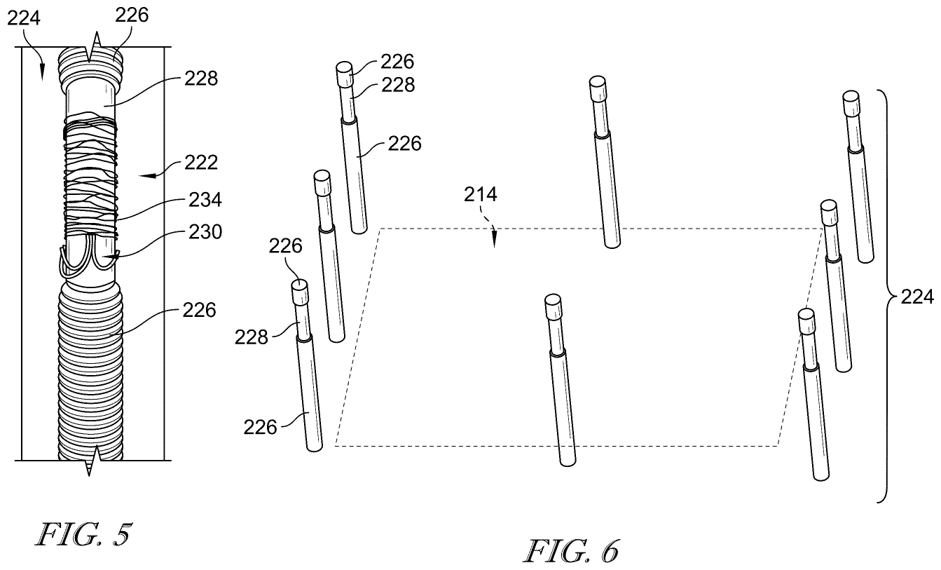

The tie rod assembly 220 may include about 1 to about 24 tie rods 224, including any specific number or range of numbers comprised therein. In some embodiments, at least one tie rod 224 is formed to include a threaded portion 226 and a non-threaded portion 228, as shown in FIGS. 5 and 6. The non-threaded portion 228 is located vertically between two threaded portions 226. Any number of the tie rods 224 may be formed to include the threaded portion 226 and/or the non-threaded portion 228, such as, for example, about 1 to about 24 tie rods 224, including any specific number or range of numbers comprised therein.

As shown in FIGS. 3 and 4, the measurement device 222 senses, determines, detects, measures, and/or calculates a variable that is indicative of the compression load applied to the stack 214. The measurement device 222 may be referred to as a compression load measurement device 222. For example, in some embodiments, the measurement device 222 is a strain gauge 222.

The strain gauge 222 is coupled with the non-threaded portion 228 of the at least one tie rod 224, as shown in FIG. 5. In other embodiments, the measurement device 222 is a load and/or pressure measuring component that is not a strain gauge. For example, the measurement device 222 is a measuring component that measures a variable other than load and/or pressure.

In some embodiments, the measurement device 222 is a strain pad. In some embodiments, the measurement device 222 is a semiconductor gauge. In some embodiments, the measurement device 222 is a force sensitive resistor. In some embodiments, the measurement device 222 is a piezoelectric strain gauge. In some embodiments, the measurement device 222 is an ultrasonic time of flight sensor. In some embodiments, the measurement device 222 is a strain gauge nut. In some embodiments, the measurement device 222 comprises a laser that measures a distance the stack 214 is moving over time (i.e., growing or relaxing). In an illustrative embodiment, the measurement device 222 is a strain gauge 222.

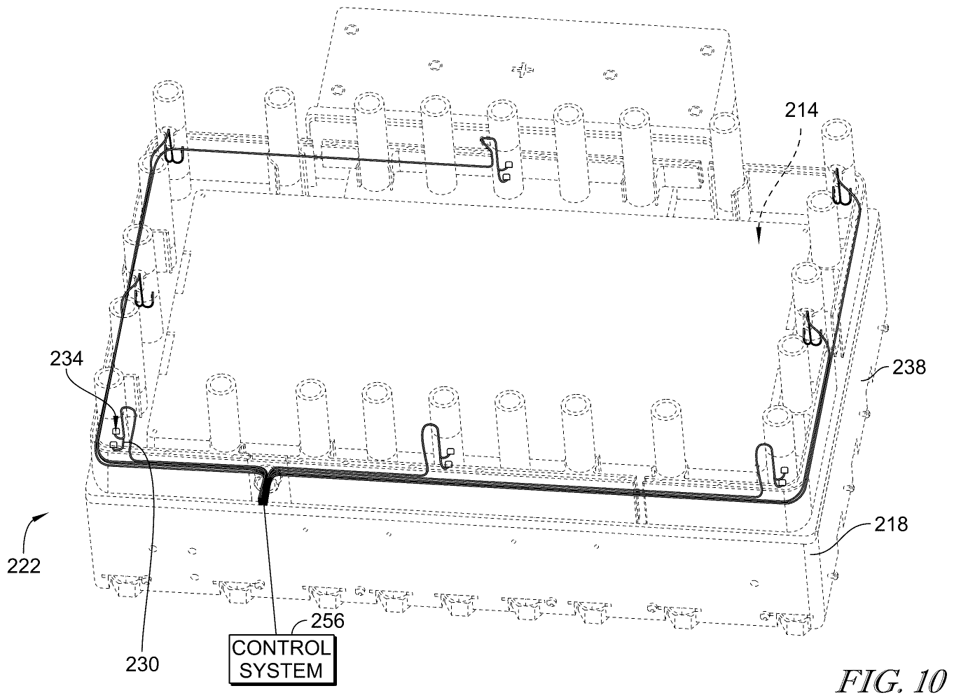

The strain gauge 222 may be coupled with any number of tie rods 224, such as, for example, about 1 to about 24 tie rods 224, including any specific number or range of numbers comprised therein. One or more tie rods 224 may be included in the plurality of tie rods 224 that are not coupled with the strain gauge 222, as shown in FIG. 10. The tie rods 224 that are not coupled with the strain gauge 222 may be entirely threaded, such that the tie rods 224 are not formed to include a non-threaded portion.

The strain gauge 222 includes at least one set of wires 230, as shown in FIGS. 4 and 10. The set of wires 230 is coupled with the non-threaded 228 portion of the at least one tie rod 224 at a first end 234 of the set of wires 230, as shown in FIG. 10. The strain gauge 222 senses, determines, detects, measures, and/or calculates a strain (e.g., pressure and/or compression load) on the at least one tie rod 224 that the set of wires 230 is coupled with. The strain as sensed, determined, detected, measured, and/or calculated by the strain gauge 222 is indicative of the compression load and/or the pressure applied to the stack 214. Thus, the strain gauge 222 allows for real-time monitoring of the compression load and/or the pressure applied to the stack 214.

Depending on a value of the real-time compression load and/or pressure measured by the measurement device 222 and/or as compared with a standard load or pressure value falling within an operational range (i.e., the desired compression load range as described above), the compression load applied to the stack 214 may be adjusted as necessary to maintain the compression load within the desired compression load range. The real-time monitoring of the compression load allows for servicing of the stack assembly 212 when necessary, and particularly within minutes, hours, and/or days. Servicing of the stack assembly 212 may include adjusting the compression load, taking the stack assembly 212 out of operation, servicing the stack assembly 212, and/or predicting an end of life of the stack assembly 212.

To adjust the compression load applied to the stack 214, a tensioning device 236, as shown in FIG. 3, may be used to reapply tension to the stack 214 to achieve the desired compression load (i.e., a compression load within the desired compression load range). For example, adjusting, retorquing, and/or reapplying the compression load on the stack 214 may be performed by hydraulically applying a load and/or reestablishing a hydraulically-applied load to achieve a compression load within the desired compression load range. Hydraulic application of the compression load on the stack 214 provides an accurate, consistent, and uniform mechanism of redistributing and/or reapplying load to the stack 214 and/or stack assembly 212 that is advantageous over manually, individually, or singularly doing so.

In some embodiments, the tensioning device 236 comprises a hydraulic tensioning device. The hydraulic tensioning device is coupled with each of the plurality of tie rods 224 so that the hydraulic tensioning device applies hydraulic pressure to stretch each of the plurality of tie rods 224 at the same time and to the same degree. The hydraulic tensioning device enables a hydraulic pressure to be applied to the stack 214 without the need to remove the compression load from the stack 214. In some embodiments, the tensioning device 236 comprises a non-hydraulic tensioning device.

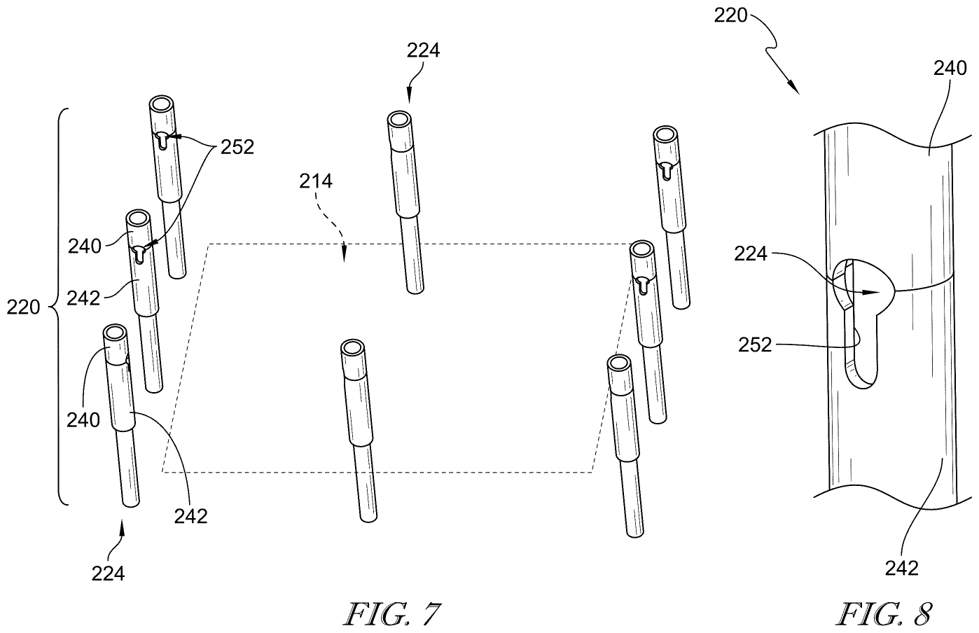

The tie rod assembly 220 further includes a first sleeve 240 and/or a second sleeve 242, as shown in FIGS. 7 and 8. The first sleeve 240 and the second sleeve 242 are hollow. The sleeves 240, 242 slide onto the tie rod 224 so that the sleeves 240, 242 are arranged outward and/or external of the tie rod 224. The first sleeve 240 and the second sleeve 242 abut one another and cooperate to form a hole 252, as shown in FIG. 8. The hole 252 is located outward of the non-threaded portion 228 of the tie rod 224. The set of wires 230 extends outwardly from the non-threaded portion 228 of the tie rod 224 through the hole 252. Illustratively, the hole 252 is formed as a keyhole shape.

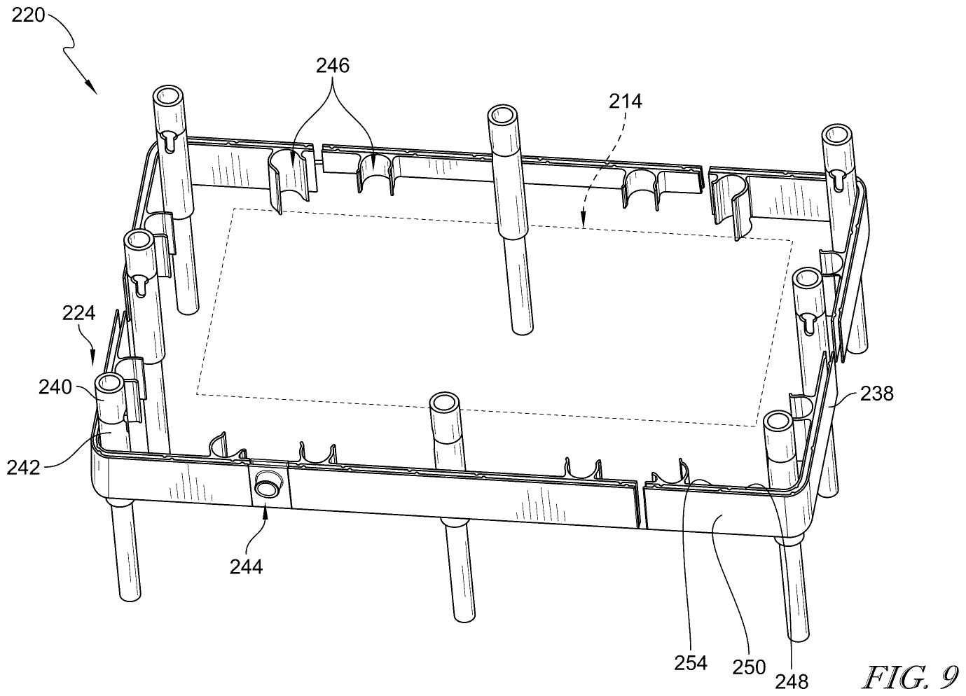

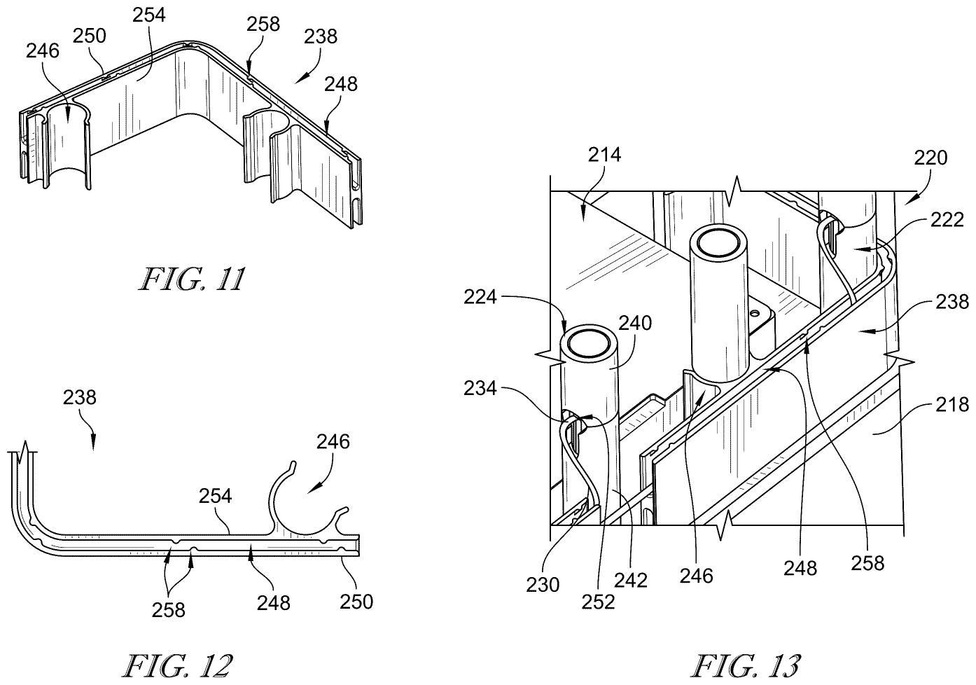

The tie rod assembly 220 further includes a housing 238, as shown in FIGS. 4, 7, and 11-13. The housing 238 is arranged on top of the second endplate 218 and extends around a perimeter of the plurality of tie rods 224 and the perimeter 282 of the stack assembly 212. The housing 238 includes an outlet port 244 and/or a plurality of clips 246, as shown in FIGS. 9 and 11-13.

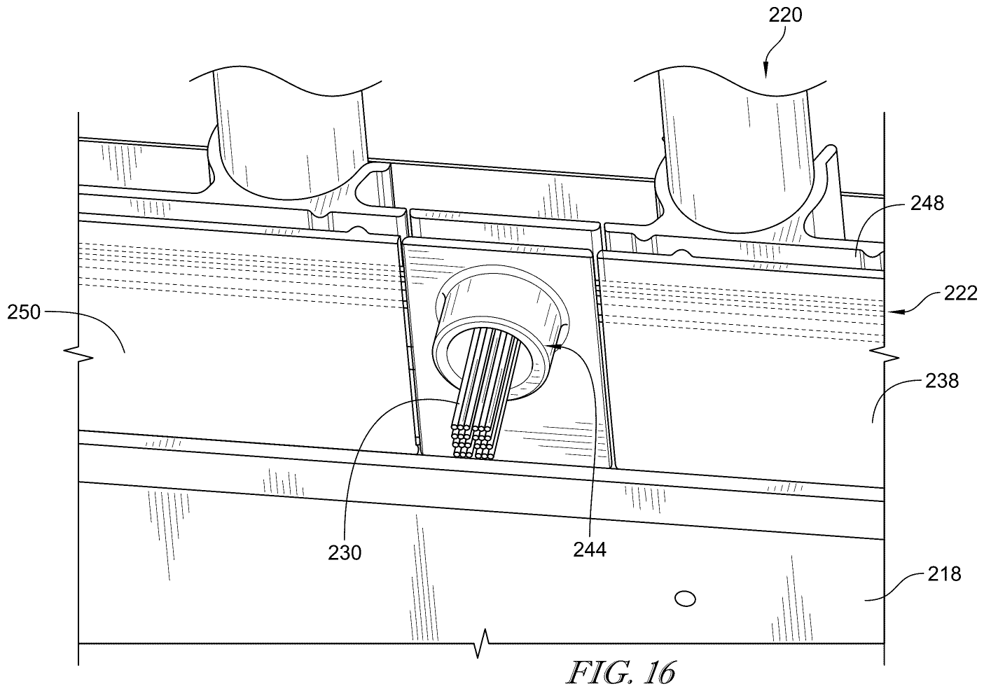

The housing 238 is formed to define a channel 248, as shown in FIG. 13. The channel 248 of the housing 238 extends around the perimeter 282 of the stack assembly 212, as shown in FIG. 4. The channel 248 is formed between an outer wall 250 and an inner wall 254 of the housing 238. The outer wall 250 is located outward or outside of the inner wall 254. The channel 248 extends entirely around the stack assembly 212. The outlet port 244 extends through the outer wall 250 of the housing 238 to open into the channel 248, as shown in FIG. 16.

The set of wires 230 extends from the non-threaded portion 228 of the tie rod 224, through the hole 252, and into the channel 248, as shown in FIGS. 4 and 13. The set of wires 230 extends through the channel 248 and exits the housing 238 through the outlet port 244. The set of wires 230 extends through the channel 248 to maintain separation between the wires 230 and the stack assembly 212 as the inner wall 254 is located therebetween. In some embodiments, the channel 248 is formed to include one or more retention features 258, as shown in FIGS. 11-13. The retention features 258 extend from the outer wall 250 toward the inner wall 254 or from the inner wall 254 toward the outer wall 250 to help maintain a positioning of the set of wires 230 within the channel 248.

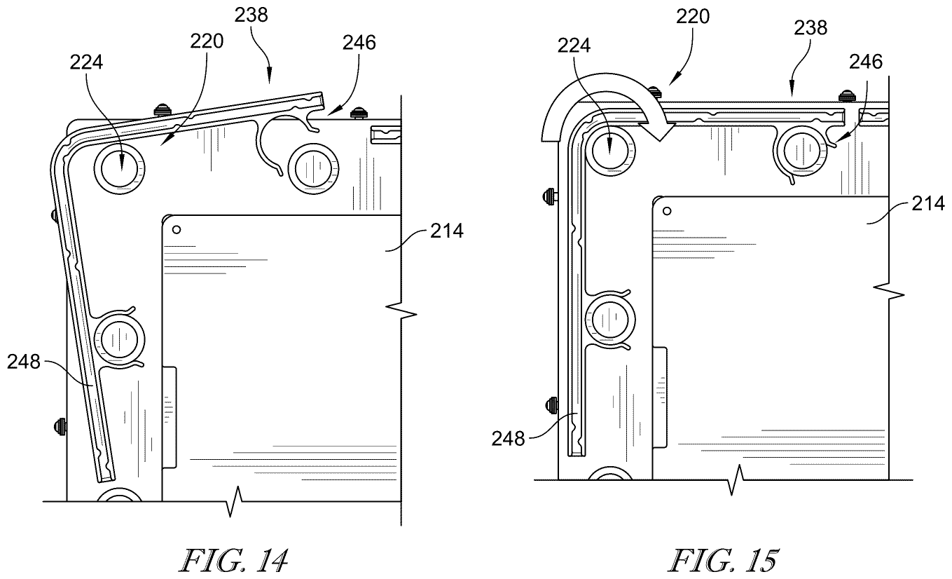

The plurality of clips 246 of the housing 238 couples the housing 238 with the plurality of tie rods 224, as shown in FIGS. 9 and 13-15. The plurality of clips 246 extends inwardly from the inner wall 254 of the housing 238. Illustratively, the plurality of clips 246 are formed as half circles that snap around the tie rods 224. In some embodiments, the housing 238 is formed of separate pieces so that the housing 238 may be assembled around the stack assembly 212. In some embodiments, the housing 238 and/or the sleeves 240, 242 are formed of a non-conductive material, such as, but not limited to, plastic material or reinforced fiber glass material.

In some embodiments, eight of the tie rods 224 are coupled to the measurement device 222, as shown in FIGS. 4 and 10. In such an embodiment, the tie rods 224 not included in the eight tie rods 224 are not coupled to the measurement device 222 and may not be formed to include any non-threaded portion. The eight tie rods 224 are located around the perimeter 282 of the stack 214. As an example, one of the eight tie rods 224 is located at a back left corner of the perimeter 282, another at a back right corner of the perimeter 282, another at a front left corner of the perimeter 282, and another at a front right corner of the perimeter 282. Another of the eight tie rods 224 is located between the ties rods 224 at the back right and left corners. Another of the eight tie rods 224 is located between the ties rods 224 at the front right and left corners. Another of the eight tie rods 224 is located between the ties rods 224 at the back right corner and the front right corner. The last of the eight tie rods 224 is located between the ties rods 224 at the back left corner and the front left corner.

In such an embodiment, the set of wires 230 is coupled to each of the eight tie rods 224, as shown in FIGS. 4 and 10. From each tie rod 224, the set of wires 230 extends through the channel 248 to the outlet port 244. It will be understood that the measurement device 222 may be coupled to any number of tie rods 224, and thus, the set of wires 230 may be coupled to any number of tie rods 224. The first and second sleeves 240, 242 extend over each tie rod 224 that is coupled to the measurement device 222.

The in situ monitoring system 210 further includes the control system 256 that communicates with the measurement device 222, as shown in FIG. 4. For example, the set of wires 230 may be coupled with the control system 256. The control system 256 may perform calculations using the variable measured by the measurement device 222 to determine the compression load applied to the stack assembly 212. The control system 256 may compare the determined compression load to the desired compression load range and/or a standard load or pressure value falling within the desired compression load range to determine if the compression load is within the desired compression load range. The determined compression load is the compression load that is sensed, determined, detected, measured, and/or calculated by the measurement device 222. The desired compression load range is the optimum range for operational performance of the stack assembly 212, as previously described. In illustrative embodiments, the determined compression load will be configured, compared, and/or adjusted (e.g., by the control system 256 or a user) to realign and fall within the desired compression load range in order to ensure optimal performance and life of the stack assembly 212.

The control system 256 may continuously monitor the compression load applied to the stack 214 as compared to the desired compression load range. The control system 256 may monitor, detect, and/or measure other system parameters, such as stack pressures, temperatures, voltages, currents, etc. The control system 256 may automatically, mechanically, and/or electronically adjust the compression load applied to the stack 214 via the tensioning device 236 based on the determined compression load and/or the desired compression load range.

The control system 256 may also issue an alert if the determined compression load is outside of the desired compression load range. In some embodiments, the alert may include a visual indicator to a user, such as a color, a light, a symbol, etc. In some embodiments, the alert may include an audio indicator to the user. In some embodiments, the alert may include a combination of a visual indicator and an audio indicator. In some embodiments, the alert may be transmitted to the user off-site. In some embodiments, the user is a human operator, a systems mechanic, or a repair technician. In some embodiments, the compression load of the stack 214 is adjusted manually by the user, and is not adjusted automatically, mechanically, or electronically by the control system 256.

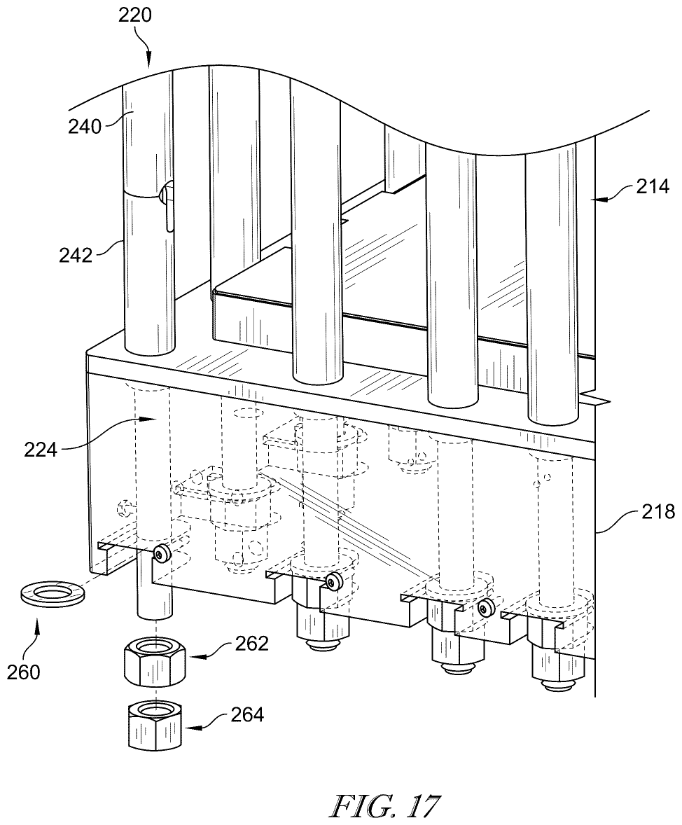

As shown in FIG. 17, to assemble the in situ monitoring system 210, a washer 260 is horizontally inserted into the second endplate 218. The second sleeve 242 slides onto the tie rod 224 from below the tie rod 224, and the first sleeve 240 slides onto the tie rod 224 from above the tie rod 224 so that the set of wires 230 extends out of the hole 252. The tie rod 224 then slides downwardly into the second endplate 218 to pass through the washer 260. The second sleeve 242 is located above the washer 260. A first nut 262 is inserted upwardly (i.e., torqued or rotated) into engagement with the washer 260. A second nut 264 is inserted upwardly (i.e., torqued or rotated) into engagement with the first nut 262, and the second nut 264 is torqued and/or tightened. Tightening the second nut 264 successfully applies compression load and/or pressure onto the stack 214 as necessary for optimum operational performance and maximum operational life of any fuel cell 20 or electrolyzer cell 80.

A method of in situ monitoring of the compression load on the stack 214 may include arranging the stack 214 between the first endplate 216 and the second endplate 218. The method may include extending the tie rod 224 between the first endplate 216 and the second endplate 218. The method may include applying the compression load to the stack 214 through the first endplate 216 and the second endplate 218. The method may include coupling the compression load measurement device 222 to the tie rod 224. The method may include measuring the compression load being applied to the stack 214 during operation of the stack 214 using the compression load measurement device 222. The method may include comparing the determined compression load with the desired compression load range.

The method may include, in response to the determined compression load being outside of the desired compression load range, issuing an alert. The method may include, in response to the determined compression load being outside of the desired compression load range, adjusting the compression load being applied to the stack 214. The step of coupling the compression load measurement device 222 to the tie rod 224 may include coupling the strain gauge 222 to the non-threaded portion 228 of the tie rod 224 and measuring the strain of the tie rod 224 to obtain a measured strain of the tie rod 224. The method may include determining the compression load being applied to the stack 214 based on the measured strain of the tie rod 224. The method may include predicting an end of life of the stack 214 based on the determined compression load.

The method may include maintaining a stationary position of the compression load measurement device 222 and the stack 214. The method may include sliding the first sleeve 240 and the second sleeve 242 onto the tie rod 224. The first sleeve 240 and the second sleeve 242 cooperate to form the hole 252 that a portion of the compression load measurement device 222 extends through. The method may include repeating the steps of determining the compression load being applied to the stack 214 during operation of the stack 214 using the compression load measurement device 222 and comparing the determined compression load with the desired compression load range throughout a life cycle of the stack 214.

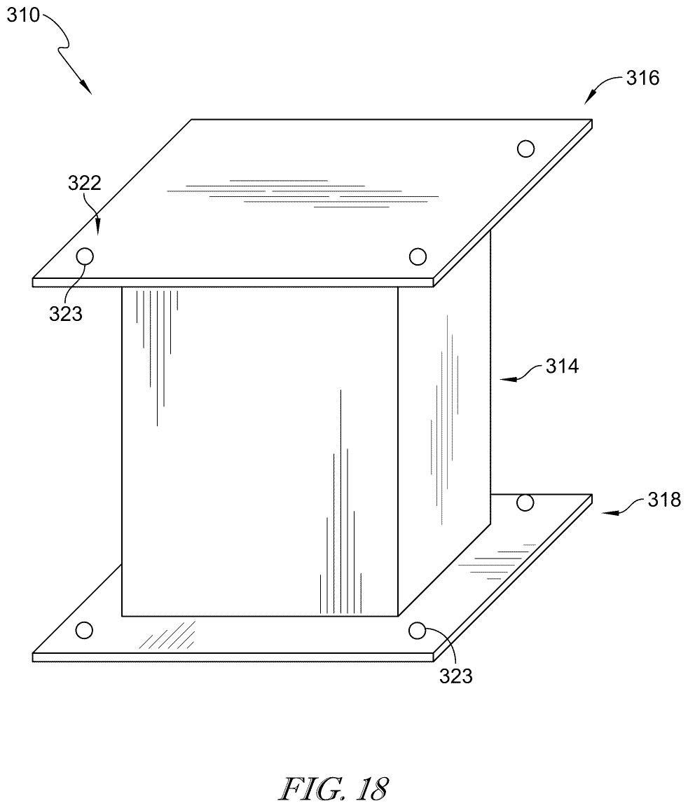

In another embodiment of an in situ monitoring system 310 disclosed herein, parallelism of endplates 316, 318 is monitored and stack 314 compression and/or tie rod extension is estimated, as shown in FIG. 18. The above disclosure related to the in situ monitoring system 210 applies to the in situ monitoring system 310.

In the in situ monitoring system 310, a measurement device 322 is not internal to the stack 314. Instead of being coupled with the tie rods, the measurement device 322 is coupled to the endplates 316, 318. The measurement device 322 comprises, in some embodiments, a single dial gauge at three points per endplate 316, 318 to measure parallelism of the endplates 316, 318.

For example, the measurement device 322 comprises a plurality of sensors 323 coupled with the endplates 316, 318, as shown in FIG. 18. One sensor 323 is coupled to a surface of the first endplate 316 adjacent a front left corner of the first endplate 316, another sensor 323 is coupled to the surface of the first endplate 316 adjacent a front right corner of the first endplate 316, and another sensor 323 is coupled to the surface of the first endplate 316 adjacent a back right corner of the first endplate 316. This sensor 323 arrangement is merely exemplary, and other arrangements on the surface of the first endplate 316 are contemplated. Any number of sensors 323 may be coupled to the first endplate 316, such as one to ten sensors, including any range or specific number comprised therein.

One sensor 323 is coupled to a surface of the second endplate 318 adjacent a front left corner of the second endplate 318, another sensor 323 is coupled to the surface of the second endplate 318 adjacent a front right corner of the second endplate 318, and another sensor 323 is coupled to the surface of the second endplate 318 adjacent a back right corner of the second endplate 318, as shown in FIG. 18. This sensor 323 arrangement is merely exemplary, and other arrangements on the surface of the second endplate 318 are contemplated. Any number of sensors 323 may be coupled to the second endplate 318, such as one to ten sensors, including any range or specific number comprised therein.

In illustrative embodiments, three sensor measurements are taken per plane (i.e., one plane for the first endplate 316 and another plane for the second endplate 318) to map out the orientation of each endplate 316, 318. The plane measurements may be used to estimate and/or determine changes in individual tie rod length and stack 314 compression. These sensors 323 are external to the stack 314. The sensors 323 are in communication with a control system, such as the control system 256.

In some embodiments, the plurality of sensors 323 are only coupled to one of the endplates 316, 318. In such an embodiment, for example, the plurality of sensors 323 are coupled to the first endplate 316 and no sensors 323 are coupled to the second endplate 323. The position of the second endplate 318 is assumed to be substantially flat or planar, and the first endplate 316 is monitored comparatively to the assumed location and position of the second endplate 318 (i.e., a reference plate).

The plurality of sensors 323 may be any one of or any combination of the following: accelerometers, gyroscopes (e.g., laser ring gyroscopes), inertial measurement units (e.g., accelerometers, gyroscopes, magnetometers), capacitive sensors, inclinometers (i.e., “Tilt sensor”), optical sensors (e.g., cameras, Position-Sensitive Detectors (PSDs)), hall effect sensors, inductive proximity sensors, ultrasonic sensors, laser distance sensors (e.g., laser interferometer).

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. An in situ monitoring system of compression load on a stack, the in situ monitoring system comprising:
a stack assembly including the stack, a first endplate arranged on a first side of the stack, and a second endplate arranged on a second side of the stack opposite the first side, wherein the first endplate and the second endplate cooperate to apply a compression load to the stack,
a tie rod assembly including a tie rod extending between the first endplate and the second endplate and configured to adjust the compression load applied to the stack through the first endplate and the second endplate, and
a compression load measurement device coupled to the tie rod or the stack assembly and configured to measure in real time the compression load applied to the stack during operation of the stack.

2. The in situ monitoring system of claim 1, wherein the stack is a fuel cell stack.

3. The in situ monitoring system of claim 1, wherein the stack is an electrolyzer stack.

4. The in situ monitoring system of claim 1, wherein the tie rod is formed to include a non-threaded portion and a threaded portion on either side of the non-threaded portion.

5. The in situ monitoring system of claim 4, wherein the compression load measurement device comprises a strain gauge coupled to the non-threaded portion of the tie rod.

6. The in situ monitoring system of claim 5, wherein the tie rod assembly includes a first sleeve and a second sleeve that each slide onto the tie rod and cooperate to form a hole, and the strain gauge extends from the non-threaded portion of the tie rod and through the hole.

7. The in situ monitoring system of claim 6, wherein the tie rod assembly includes a second tie rod extending between the first endplate and the second endplate and an entirety of the second tie rod is threaded.

8. The in situ monitoring system of claim 1, further comprising a controller operably connected to the compression load measurement device and configured to compare the compression load as determined by the compression load measurement device to a desired compression load range.

9. The in situ monitoring system of claim 1, wherein the in situ monitoring system is stationary.

10. A method of in situ monitoring of a compression load on a stack, the method including:
arranging the stack between a first endplate and a second endplate,
extending a tie rod between the first endplate and the second endplate,
applying the compression load to the stack through the first endplate and the second endplate,
coupling a compression load measurement device to the tie rod or at least one of the first endplate and the second endplate,
measuring the compression load being applied to the stack during operation of the stack using the compression load measurement device to determine a determined compression load, and
comparing the determined compression load with a desired compression load range.

11. The method of claim 10, further comprising issuing an alert in response to the determined compression load being outside of the desired compression load range.

12. The method of claim 10, further comprising adjusting the compression load being applied to the stack in response to the determined compression load being outside of the desired compression load range.

13. The method of claim 10, wherein the step of coupling a compression load measurement device includes coupling a strain gauge to a non-threaded portion of the tie rod and measuring a strain of the tie rod to obtain a measured strain of the tie rod.

14. The method of claim 13, further comprising determining the compression load being applied to the stack based on the measured strain of the tie rod.

15. The method of claim 10, wherein the stack is a fuel cell stack.

16. The method of claim 10, wherein the stack is an electrolyzer stack.

17. The method of claim 10, further comprising predicting an end of life of the stack based on the determined compression load.

18. The method of claim 10, further comprising maintaining a stationary position of the compression load measurement device and the stack.

19. The method of claim 10, further comprising sliding a first sleeve and a second sleeve onto the tie rod, the first sleeve and the second sleeve cooperating to form a hole that a portion of the compression load measurement device extends through.

20. The method of claim 10, further comprising repeating the steps of determining the compression load being applied to the stack during operation of the stack using the compression load measurement device and comparing the determined compression load with the desired compression load range throughout a life cycle of the stack.
